(19) United States
(12) Patent Application Publication
(10) Pub. No.: US 2015/0341090 A1
(43) Pub. Date: Nov. 26, 2015

(54) APPARATUS AND METHOD FOR PROCESSING TRANSMISSION/RECEPTION SIGNALS FOR INTERFERENCE ALIGNMENT IN MU-MIMO INTERFERING BROADCAST CHANNEL

(71) Applicant: Electronics and Telecommunication Research Institute, Daejeon (KR)

(72) Inventors: Jinhyung OH, Daejeon (KR); Hyun Ho LEE, Daejeon (KR); Young Chai KO, Daejeon (KR); Myeong Jin KIM, Daejeon (KR); Gwangzeen KO, Daejeon (KR); Igor KIM, Daejeon (KR); Myung Sun SONG, Daejeon (KR)

(21) Appl. No.: 14/598,334

(22) Filed: Jan. 16, 2015

(30) Foreign Application Priority Data
May 21, 2014 (KR) 10-2014-0061220

(51) Int. Cl. H04B 7/04; H04B 15/00

(52) U.S. Cl. CPC H04B 7/0417; H04B 7/0456; H04B 15/00

(57) ABSTRACT

A method comprising: determining, by a transmitter, a fixed number of effective IAI channels; estimating, by a receiver, channel information H through information provided from the transmitter; sharing, by a receiver, the channel information among a plurality of receivers that are belonging to a same BSS (Basic Service Set); calculating effective IAI channel information q and decoding vector u using the channel information; feeding back the calculated effective IAI channel information q and decoding vector u to the transmitter; and calculating, by the transmitter, a transmitting precoding vector, after sharing the fed-back effective IAI channel information q and decoding vector u, and the channel information H among a plurality of other transmitters.

### RELATED APPLICATIONS

This application is based on and claims priority to Korean Patent Application No. 10-2014-0061220, filed on May 21, 2014, the disclosure of which is incorporated herein in its entirety by reference.

### FIELD OF THE INVENTION

The present invention relates to a processing of transmission and reception signals in a wireless system, and more particular, to an apparatus and method for processing transmission/reception signals for interference alignment in MU-MIMO (Multi-User Multiple-Input and Multiple-Output) interference channel network for an access point (AP) and a plurality of mobile stations such as mobile phones to configure links.

### BACKGROUND OF THE INVENTION

In recent, with the increase of the use of wireless devices and the amount of data transmission causing a large amount of traffics such as high definition video transmission, a plurality of wireless LAN (Local Area Network) APs (Access Points) have been indiscriminately installed in order to address the aforementioned issues. This results in the occurrence of interference of signals between adjacent APs. The interference between the adjacent APs leads to the deterioration of overall system performance.

An interference alignment has been proposed in order to solve the interference issues. The interference alignment refers to a technique that aligns interference signals to specific resources, e.g., such as time, space, frequency, etc. and secures the resources as much as possible so that desired signals can be transmitted through the resources. For example, in a case where the interference alignment is performed by using multiple antennas in a wireless LAN environment, it aligns interference signals arrived from other APs to specific space resources when desired signals are received by a mobile station STA. Consequently, spaces through which the desired signals are transmitted can be fully secured, which facilitates the separation of the desired signal from the interference signals. Using the interference alignment allows for the users within the interference channel environment to maximally utilize DoF (Degree Of Freedom) up to a half of the overall antenna resources. The term of DoF used herein means a maximum number of streams by which signals can be transmitted without any interference in the interference channel environment.

As such, the interference alignment has attracted a lot of attention in terms of being able to solve the problem of interference between adjacent APs.

However, the interference alignment has several disadvantages that a complex calculation is required at the time of obtaining precoding/decoding matrices that are used in transmission and reception ends, each node needs to know the large amount of wireless channel condition information, and the number of antennas should be increased in order to make null the aligned interference in proportion to the number of interference sources.

### SUMMARY OF THE INVENTION

In view of the above, the present invention provides an apparatus and method for producing a reception beam-forming matrix capable of improving performance in an operating SNR band on a basis of an SLNR (Signal to Leakage Interference and Noise Ratio) and interference alignment technique in a network environment having a plurality of MU-MIMI links.

In accordance with an embodiment of the present invention, a method comprising: determining, by a transmitter, a fixed number of effective IAI channels; estimating, by a receiver, channel information H through information provided from the transmitter; sharing, by a receiver, the channel information among a plurality of receivers that are belonging to a same BSS (Basic Service Set); calculating effective IAI channel information q and decoding vector u using the channel information; feeding back the calculated effective IAI channel information q and decoding vector u to the transmitter; and calculating, by the transmitter, a transmitting precoding vector, after sharing the fed-back effective IAI channel information q and decoding vector u, and the channel information H among a plurality of other transmitters.

In the embodiment, said determining the effective IAI channels comprises determining the number of IAI channels, n_{j,i}^{(s)}, aligned in an m-th basis vector q_{j,i,m}^{(s)} and the number of the effective IAI channels, t_{j,i}, wherein an s-th effective IAI channel is expressed as the following Equation: Q_{j,i}^{(s)}=[q_{j,i,1}^{(s)}, q_{j,i,2}^{(s)}, . . . , q_{j,i,d}^{(s)}], where d denotes the number of streams to be received by the respective users.

In the embodiment, said determining the effective IAI channels comprises: determining, each adjacent AP, a total number of IAI channels from an IAI channel on which an adjacent AP affects a first user device to another IAI channel on which the adjacent AP affects an n_{j,i}⁽¹⁾-th user device supported by the receiver as a first effective channel, q_{j,i,m}⁽¹⁾; determining, each adjacent AP, a total number of IAI channels from an IAI channel on which an adjacent AP affects an n_{j,i}⁽¹⁾+1-th user device supported by the receiver to another IAI channel on which the adjacent AP affects an n_{j,i}⁽¹⁾+n_{j,i}⁽²⁾-th user device as a second effective channel, q_{j,i,m}⁽²⁾; and determining, each adjacent AP, Kⱼ number of IAI channels on which the adjacent AP affects a user device supported by the receiver as t_{j,i} number of effective channels, q_{j,i,1}^{(s)}, q_{j,i,2}^{(s)}, . . . , q_{j,i,d}^{(s)}

In accordance with an embodiment of the present invention, there is provided an apparatus for processing interference alignment signals (IAI) in a network environment having a plurality of MU-MIMO (Multi User-Multiple Input and Multiple Output) links made up of a plurality of transmitters and receivers, which includes: an effective IAI determining unit adapted to determine effective IAI channels; a channel information sharing unit adapted to share the effective channel information, channel information H and decoding vector u to be fed-back from the receivers; and a precoding vector producing unit adapted to produce precoding vector through the use of the effective IAI channel information, the channel information H, and the decoding vector u.

In the embodiment, the precoding vector is employed to perform the precoding on signals to be transmitted from the transmitters to the receivers.

In accordance with an embodiment of the present invention, there is provided an apparatus for processing interference alignment signals (IAI) in a network environment having a plurality of MU-MIMO (Multi User-Multiple Input and Multiple Output) links made up of a plurality of transmitters and receivers, which includes: a channel estimation unit adapted to estimate channel information H based on signals received from the transmitters; a channel information sharing unit adapted to share the estimated channel information among the plurality of receivers that belong to a same BSS (Basic Service Set); a decoding vector producing unit adapted to produce a decoding vector u using the channel information; and a feedback unit adapted to feed back the channel information and the decoding vector to the receivers.

According to the embodiments of the present invention, the transmission/reception signal processing apparatus enables to solve the interference issues in an MU-MIMO environment having a plurality of MU-MIMI links and improve an overall system sum-rate.

### BRIEF DESCRIPTION OF THE DRAWINGS

The above and other objects and features of the present invention will become apparent from the following description of the embodiments given in conjunction with the accompanying drawings, in which:

FIG. 1 is a block diagram of a wireless communication system to which an embodiment of the present invention is applied;

FIG. 2 illustrates a channel allocation algorithm to which an embodiment of the present invention is applied;

FIG. 3 is a block diagram of a transmission signal processing apparatus and a reception signal processing apparatus for interference alignment that are respectively included in a transmitter and a receiver in accordance with the embodiment of the present invention;

FIG. 4 illustrates a flow diagram of a process of producing a reception beam-forming matrix and a transmission precoding vector by a transmitter and receiver in a wireless communication system in accordance with an embodiment of the present invention;

FIGS. 5A to 5F depicts conceptual diagrams illustrating the interference alignment performed between a transmitter and a receiver in a wireless communication system in accordance with an embodiment of the present invention; and

FIG. 6 represents a graph comparing performance between a wireless communication system to which an embodiment of the present invention is applied and an existing wireless communication system.

### DETAILED DESCRIPTION OF THE EMBODIMENTS

The advantages and features of exemplary embodiments of the present invention and methods of accomplishing them will be clearly understood from the following description of the embodiments taken in conjunction with the accompanying drawings. However, the present invention is not limited to those embodiments and may be implemented in various forms. It should be noted that the embodiments are provided to make a full disclosure and also to allow those skilled in the art to know the full scope of the present invention. Therefore, the present invention will be defined only by the scope of the appended claims. Similar reference numerals refer to the same or similar elements throughout the drawings.

In the following description, well-known functions or constitutions will not be described in detail if they would unnecessarily obscure the features of the subject matter of the present disclosure. in unnecessary detail. Further, the term to be described below are defined in consideration of functions in the present disclosure and may vary depending on intentions or practices of a user or an operator. Accordingly, the definition may be made on a basis of the content throughout the specification.

In general, in communication environment where there exists interference between users, it is very important to effectively manage and eliminate interference from other users. Otherwise, the interference makes it difficult to obtain a high channel capacity. Consequently, studies have mainly been made to avoid or diminish the interference. As representative examples, a method of frequency division multiple access or time division multiple access allows not to occur the interference by distributing frequency or time among users to be orthogonal to each other.

Meanwhile, next generation wireless communication systems are intended to provide high communication capacity to users in a way of disposing a plurality of small base stations having a small coverage.

In these systems, a user may receive intensive signals from several base stations. However, it is known in the art that high channel capacity serviced by the wireless communication system cannot be obtained through existing interference avoidance or diminishing technologies.

Therefore, in recent years, an interference alignment technique has been proposed and studied to obtain high channel capacity from interference channels formed in wireless communication systems, e.g., femto-cell communication systems.

In this regard, performance in the interference alignment technique is measured in terms of DoF. Herein, the term of DoF represents the number of resources by which communication can be made without any interference in MIMO channel environment. In terms of capacity, the DoF may also represented by a slope in a capacity graph of a SNR-capacity graph.

Such a DoF is a metric when SNR increases infinitely, as indicated in the Equation 1 below. In this case, the slope of the capacity is considered as a critical measurement element and thus the capacity itself is not considered as significant value. Further, the interference alignment technique basically takes into account only interference among dominant elements in an interference limited environment, which results in deteriorated performance in an operating SNR band in which a communication system is actually activated. This is because that the interference alignment technique pays no attention to noise of another dominant element having an effect on the performance in spite of the importance of both the interference and noise.

$$DoF = {lim}_{SNR \to ∞} \frac{C ( SNR )}{log ( SNR )} \qquad [ EQUATION 1 ]$$

In other words, the interference alignment technique measures the system performance in terms of the DoF and thus is insufficient to increase the capacity. In particular, it suffers from a deteriorated performance in the operating SNR band in which the communication system is practically activated.

In addition to the interference in the operating band for the actual system, the noise also influences sum-rate to bring about the degradation of performance from the interference alignment algorithm which relies on the interference. Additionally, while the interference alignment algorithm may improve the performance in high SNR band, it cannot exhibit the improved performance in the bands lower than the aforementioned band.

Therefore, in order to improve the system performance, it is inevitable to improve the system performance in the operating SNR band.

To do it, embodiments of the present invention introduce a novel interference alignment technique to improve the system performance in the operating SNR band.

In this regard, a most important factor in the interference alignment technique is the formation of beamforming at a receiver end and the production of a precoding matrix or vector at a transmitter end based on the beamforming, which may be core techniques to design cell base stations in a next generation wireless communication system.

Hereinafter, it will be described that the formation of beamforming at a receiver end and the production of a precoding matrix or vector at a transmitter end.

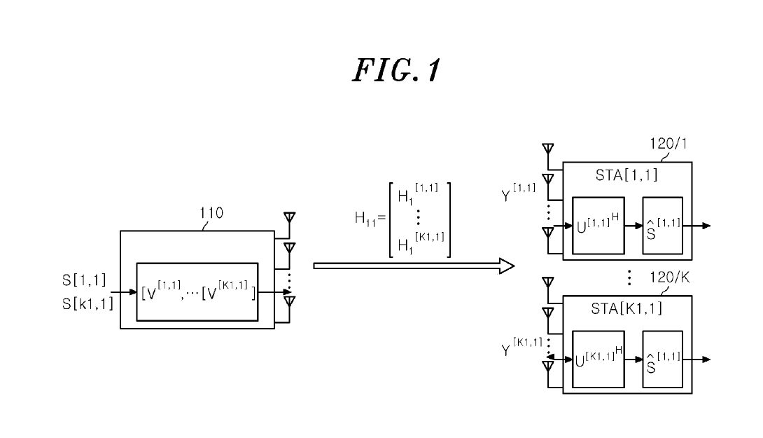

FIG. 1 is a block diagram of a wireless communication system to which an embodiment of the present invention is applied.

Referring to FIG. 1, one MU-MIMO link is made up of one AP (Access Point) having multiple antennas and a plurality of mobile stations (also referred to abbreviately as “STA”) 120/1-120/k, and an interference channel network environment is configured by the combination of a plurality of MU-MIMO links. The MU-MIMO used herein means a technique to increase a channel capacity in limited frequency resources in a way that multiple antennas are employed in transmitting and receiving ends, e.g., the AP and the mobile stations.

In interference wireless communication systems, APs 110 are in communication with each other through a same channel, and therefore, the individual AP may make interference to other STAB 120/1-120/k.

In FIG. 1, it is assumed that each AP 110 is provided with Mi-number of antennas and each STA 120/1-120/k is provided with Ni-number of antennas. Letting a channel from a j-th AP 110 to a k-th STA 120/k within an i-th cell be Hᵢ^{[k,j]}, a signal received by an i-th user terminal in the i-th cell can be expressed the Equation 2 below.

$${y}^{[ k , i ]} = {H}_{i}^{[ k , i ]} {V}^{[ k , i ]} {s}^{[ k , i ]} + {\sum }_{{l = 1}_{l \neq k}}^{Ki} {H}_{i}^{[ k , i ]} {V}^{[ l , i ]} {s}^{[ l , i ]} + {\sum }_{{j = 1}_{j \neq k}}^{C} {\sum }_{l = 1}^{Ki} {H}_{j}^{[ k , i ]} {V}^{[ l , j ]} {s}^{[ l , j ]} + {n}^{[ k , i ]} \qquad [ EQUATION 2 ]$$

where Hᵢ^{[k,i]}V^{[k,i]}s^{[k,i]} represents a desired signal which passes through a channel at an i-th AP 110 for the user terminal;

$${\sum }_{{l = 1}_{l \neq k}}^{Ki} {H}_{i}^{[ k , i ]} {V}^{[ l , i ]} {s}^{[ l , i ]}$$

represents an inter-user interference signal from a j-th AP to other users in the same cell; and

$${\sum }_{{j = 1}_{j \neq k}}^{C} {\sum }_{l = 1}^{Ki} {H}_{j}^{[ k , i ]} {V}^{[ l , j ]} {s}^{[ l , j ]}$$

represents an inter-AP interference signal from the j-th AP to the users in other cells. Further, n^{[k,i]} represents noise in a receiver; and V^{[1,j]}s^{[1,j]} represents a signal that is subjected to a precoding at the receiver and the transmitter.

The precoded signal may be expressed the Equation 3 below.

y^{[k,i]}=V^{[k,i]}s_{[k,i]} [EQUATION 3]

where V^{[k,i]} and s^{[k,i]} are a precoding matrix (Mᵢ×d) (where d is the number of streams to be transmitted by an AP) and a signal intended to be transmitted, respectively, for a k-th user in the i-th cell.

Rearranging the Equation 2 using the Equation 3 will become the Equation 4 below.

$${y}^{[ k , i ]} = {H}_{i}^{[ k , i ]} {x}^{[ k , i ]} + {\sum }_{{l = 1}_{l \neq k}}^{Ki} {H}_{i}^{[ k , i ]} {x}^{[ l , i ]} + {\sum }_{{j = 1}_{j \neq k}}^{C} {\sum }_{l = 1}^{Ki} {H}_{j}^{[ k , i ]} {x}^{[ l , j ]} + {n}^{[ k , i ]} \qquad [ EQUATION 4 ]$$

The Equation 4 denotes the type of a signal before being subjected to a decoding process at the STAB 120/1-120/k. A signal after being subjected to a decoding matrix is represented as the Equation 5 below.

$${\tilde{y}}^{[ k , i ]} = {U}^{[ k , i ]} {H}_{i}^{[ k , i ]} {V}^{[ k , i ]} {s}^{[ k , i ]} + {U}^{{[ k , i ]}^{H}} {\sum }_{{l = 1}_{l \neq k}}^{Ki} {H}_{i}^{[ k , i ]} {V}^{[ l , i ]} {s}^{[ l , i ]} + {U}^{{[ k , i ]}^{H}} {\sum }_{{j = 1}_{j \neq k}}^{C} {\sum }_{l = 1}^{Ki} {H}_{j}^{[ k , i ]} {V}^{[ l , j ]} {s}^{[ l , j ]} + {U}^{{[ k , i ]}^{H}} {n}^{[ k , i ]} \qquad [ EQUATION 5 ]$$

where a decoding matrix U^{[k,i]}^{^{H}} denotes a reception signal processing matrix having a size of Mᵢ×d.

A sum-rate of an i-th receiver to which the Equation 5 is reflected is expressed the Equation 6 below.

$${R}^{[ k , i ]} = {\sum }_{m = 1}^{d} {log}_{2} [ 1 + \frac{\frac{1}{{K}_{i} d} {\vert {u}_{m}^{{[ k , i ]}^{H}} {H}_{i}^{[ k , i ]} {v}_{m}^{[ k , i ]} \vert}^{2}}{( \begin{matrix}\frac{1}{ρ} {‖ {u}_{m}^{[ k , i ]} ‖}^{2} + {\sum }_{{n = 1}_{n \neq m}}^{d} \frac{1}{{K}_{i} d} {\vert {u}_{m}^{{[ k , i ]}^{H}} {H}_{i}^{[ k , i ]} {v}_{n}^{[ k , i ]} \vert}^{2} + \\ {\sum }_{{l = 1}_{l \neq k}}^{{K}_{i}} {\sum }_{{n = 1}_{n \neq m}}^{d} \frac{1}{{K}_{i} d} {\vert {u}_{m}^{{[ k , i ]}^{H}} {H}_{i}^{[ k , i ]} {v}_{n}^{[ k , i ]} \vert}^{2} + {\sum }_{{j = 1}_{j \neq i}}^{C} {\sum }_{{l = 1}_{l \neq k}}^{{K}_{i}} {\sum }_{{n = 1}_{n \neq m}}^{d} \frac{1}{{K}_{i} d} {\vert {u}_{m}^{{[ k , i ]}^{H}} {H}_{i}^{[ k , i ]} {v}_{n}^{[ k , i ]} \vert}^{2}\end{matrix} )} ] \qquad [ EQUATION 5 ]$$

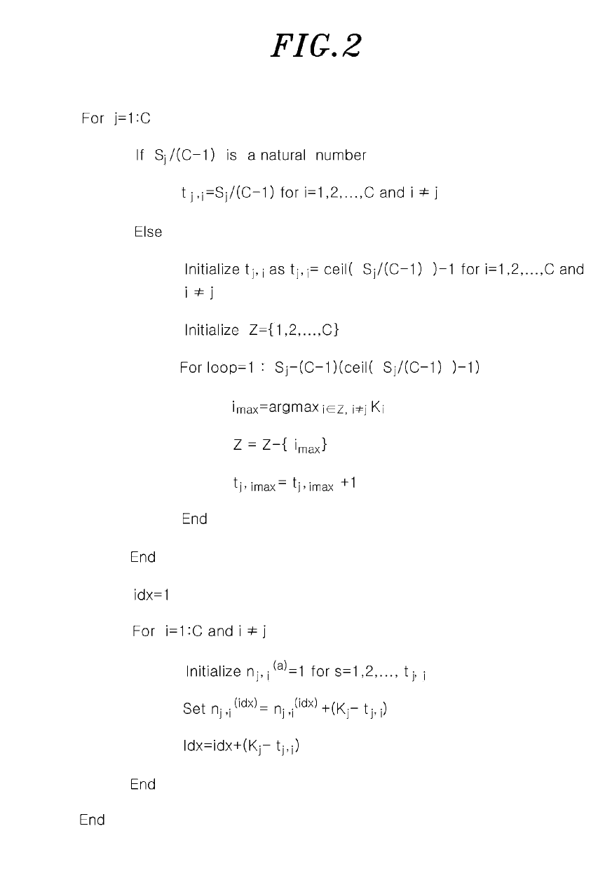

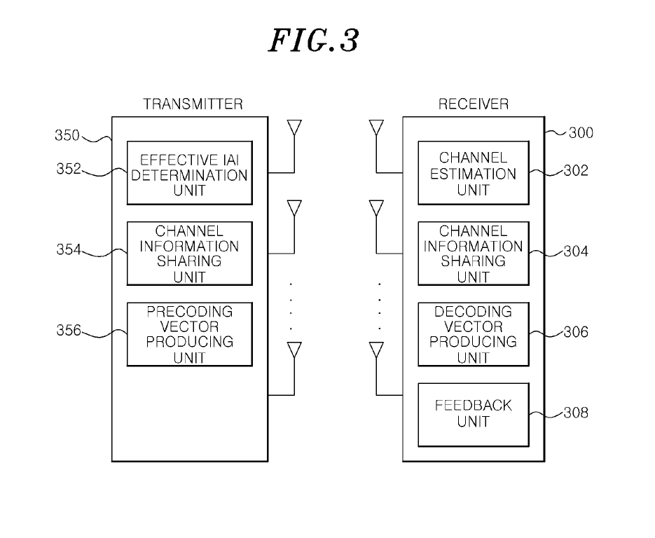

The following is a description of a process to solve the interference issue in the wireless communication system of FIG. 1 and produce the receiving beam-forming matrix for improving the sum-rate. The process will be discussed with reference to FIGS. 2 and 3 in detail.

FIG. 3 is a block diagram of a transmission signal processing apparatus and a reception signal processing apparatus for interference alignment that are respectively included in a transmitter and a receiver in accordance with the embodiment of the present invention. A receiver 300 of FIG. 3 may correspond with the STA such as mobile telephones. The receiver 300 may include a channel estimation unit 302, a channel information sharing unit 304, a decoding vector producing unit 306, and a feedback unit 308, which may compose the receiving signal processing apparatus for interference alignment.

The channel estimation unit 302 estimates channel information H based on signal received from the transmitter 350 such as the AP or the like. The channel information used herein may include amplitude and phase of wireless channels. Such channel information may serve to produce a precoder and a decoder.

The channel information sharing unit 304 shares the channel information estimated by the channel estimation unit 302 among a plurality of the receivers affiliated to each BSS (Basic Service Set) so that an effective IAI (Inter-AP Interference) channels ‘q’ and decoding vector ‘u’ can be calculated. The term BSS used herein is employed in wireless LAN standard to means the same concept as a cell used in a cellular network.

The decoding vector producing unit 306 serves to produce the decoding vector u. Specifically, the decoding vector producing unit 306 produces the decoding vector u and the effective IAI channels q through the use of the channel information acquired on a basis of preamble data transmitted from the transmitter 350.

The feedback unit 308 feeds back the decoding vector u and the effective IAI channels q that are produced by the decoding vector producing unit 306 and the channel information H to the transmitter 350.

In accordance with the embodiment of the present invention, the receiver 300 may produce a receiving beamforming matrix for aligning IAI channels in order to maximize an overall wireless communication network DoF or multiplexing gain as follows.

First, the number of IAI channels from the users supported by a j-th AP 110 become (C−1)Kᵢ channels in total, and they are aligned as the effective IAI channels of the number of sⱼ.

When the number of effective IAI channels on which an i-th AP 110 affects the users supported by the j-th AP 110 is t_{j,i} (where i≠j), the IAI channels of the number of Kⱼ are aligned as the effective IAI channels of the number of t_{j,i}.

An s-th effective IAI channel on which the i-th AP 110 affects the users supported by the j-th AP 110 can be expressed the Equation 7 below.

Q_{j,i}^{(s)}=[q_{j,i,1}^{(s)}, q_{j,i,2}^{(s)}, . . . , q_{j,i,d}^{(s)}] [EQUATION 7]

where d denotes the number of streams to be received by the respective users.

Meanwhile, when the number of IAI channels aligned in an m-th basis vector q_{j,i,m}^{(s)} is the number of n_{j,i}^{(s)}, it is needed to effectively determine the number of t_{j,i} and n_{j,i}^{(s)} in order not to increase of the unnecessary antennas due to the IAI channels more than enough aligned to one effective IAI channel.

Thus, the transmitter 350 may determines the number of the effective IAI channels, t_{j,i}, and the number of IAI channels, n_{j,i}^{(s)}, which is aligned in the m-th basis vector q_{j,i,m}^{(s)}, using an IAI channel allocation algorithm. For example, such an IAI channel allocation algorithm is illustrated in FIG. 2, but is not limited thereto.

Thereafter, the receiver 300 aligns the IAI channels on which i-th AP 110 affects the users supported by the j-th AP 110 in the effective IAI channels. The alignment process will be disclosed as follows.

First, the result of the alignment can be expressed as the Equation 8 below.

$$span ( {q}_{j , i , m}^{( 1 )} ) = span ( {H}_{i}^{[ 1 , j ] H} {u}_{m}^{[ 1 , j ]} ) = … = span ( {H}_{i}^{[ {n}_{j , i}^{( 1 )} , j ] H} {u}_{m}^{[ 1 , j ]} ) \\ span ( {q}_{j , i , m}^{( 2 )} ) = span ( {H}_{i}^{[ {n}_{j , i}^{( 1 )} + 1 , j ] H} {u}_{m}^{[ {n}_{j , i}^{( 1 )} + 1 , j ]} ) = … = span ( {H}_{i}^{[ {n}_{j , i}^{( 1 )} + {n}_{j , i}^{( 2 )} , j ] H} {u}_{m}^{[ {n}_{j , i}^{( 1 )} + {n}_{j , i}^{( 2 )} , j ]} ) \\ span ( {q}_{j , i , m}^{( {t}_{j , i} )} ) = span ( {H}_{i}^{[ {n}_{j , i}^{( 1 )} + … + {n}_{j , i}^{( {t}_{j , i} - 1 )} , j ] H} {u}_{m}^{[ {n}_{j , i}^{( 1 )} + … + {n}_{j , i}^{( {t}_{j , i} - 1 )} , j ]} ) = … = span ( {H}_{i}^{[ {K}_{j} , j ] H +} {u}_{m}^{[ {K}_{j} , j ]} ) \qquad [ EQUATION 8 ]$$

As depicted in the Equation 8, a total number of IAI channels of n_{j,i}⁽¹⁾ from an IAI channel of Hᵢ^{[1,k]H}uₘ^{[1,j]} on which an i-th AP 110 affects a first user supported by an j-th AP 110 to an IAI channel of

$${H}_{i}^{[ {n}_{j , i}^{( 1 )} , j ]} {u}_{m}^{[ 1 , j ]}$$

on which an i-th AP 110 affects an n_{j,k}⁽¹⁾-th user supported by an j-th AP 110 is aligned in a first effective channel of q_{j,i,m}⁽¹⁾. Likewise, a total of IAI channels of n_{j,i}⁽¹⁾+1 from an IAI channel of

$${H}_{i}^{[ {n}_{j , i}^{( n )} + 1 , j ] H} {u}_{m}^{[ {n}_{j , i}^{( 1 )} + 1 , j ]}$$

on which an i-th AP 110 affects a first user supported by an j-th AP 110 to an IAI channels of

$${H}_{i}^{[ {n}_{j , i}^{( 1 )} + {n}_{j , i}^{( 2 )} , j ] H} {u}_{m}^{[ {n}_{j , i}^{( 1 )} + {n}_{j , i}^{( 2 )} , j ]}$$

on which an i-th AP 110 affects an n_{j,i}⁽²⁾-th user supported by an j-th AP 110 is aligned in a second effective channel of q_{j,i,m}⁽²⁾. The Equation 8 may be expressed as the Equation 9.

$${q}_{j , i , m}^{( 1 )} = {H}_{i}^{[ 1 , j ] H} {u}_{m}^{[ 1 , j ]} = … = {H}_{i}^{[ {n}_{j , i}^{( 1 )} , j ] H} {u}_{m}^{[ 1 , j ]} \\ {q}_{j , i , m}^{( 2 )} = {H}_{i}^{[ {n}_{j , i}^{( 1 )} + 1 , j ] H} {u}_{m}^{[ {n}_{j , i}^{( 1 )} + 1 , j ]} = … = {H}_{i}^{[ {n}_{j , i}^{( 1 )} + {n}_{j , i}^{( 2 )} , j ] H} {u}_{m}^{[ {n}_{j , i}^{( 1 )} + {n}_{j , i}^{( 2 )} , j ]} \\ {q}_{j , i , m}^{( {t}_{j , i} )} = {H}_{i}^{[ {n}_{j , i}^{( 1 )} + … + {n}_{j , i}^{( {t}_{j , i} - 1 )} , j ] H} {u}_{m}^{[ {n}_{j , i}^{( 1 )} + … + {n}_{j , i}^{( {t}_{j , i} - 1 )} , j ]} = … = {H}_{i}^{[ {K}_{j} , j ] H} {u}_{m}^{[ {K}_{j} , j ]} \qquad [ EQUATION 9 ]$$

Further, the Equation 9 may be represented by the Equation 10 below.

$$\text{?} = 0 \\ \text{?} \text{indicates text missing or illegible when filed} \qquad [ EQUATION 10 ]$$

In the Equation 10, A_{j,i}^{(s)} is composed of n_{j,i}^{(s)} number of unit matrices I_{M}_{ⱼ} having a magnitude of Mᵢ×Mᵢ and the Kⱼ−n_{j,i}^{(s)} number of null matrices 0_{M}_{ᵢ} having a magnitude of Mᵢ×Mᵢ. A_{j,i} is composed of t_{j,i} number of A_{j,i}^{(s)}, and is represented as the following Equation 11.

$$\begin{matrix}{A}_{j , i}^{( 1 )} = {[ \underbrace{{I}_{{M}_{i}} , … {I}_{{M}_{i}}}_{{M}_{i} \times {n}_{j , i}^{( 1 )} {M}_{i}} , \underbrace{{0}_{{M}_{i}} , … {0}_{{M}_{i}}}_{{M}_{i} \times ( {K}_{j} - {n}_{j , i}^{( 1 )} ) {M}_{i}} ]}^{T} \\ {A}_{j , i}^{( 2 )} = {[ \underbrace{{0}_{{M}_{i}} , … {0}_{{M}_{i}}}_{{M}_{i} \times {n}_{j , i}^{( 1 )} {M}_{i}} , \underbrace{{I}_{{M}_{i}} , … {I}_{{M}_{i}}}_{{M}_{i} \times {n}_{j , i}^{( 2 )} {M}_{i}} , \underbrace{{0}_{{M}_{i}} , … {0}_{{M}_{i}}}_{{M}_{i} \times ( {K}_{j} - {n}_{j , i}^{( 1 )} - {n}_{j , i}^{( 2 )} ) {M}_{i}} ]}^{T} \\ ⋮ \\ {A}_{j , i}^{( {t}_{j , i} )} = {[ \underbrace{{0}_{{M}_{i}} , … {0}_{{M}_{i}}}_{{M}_{i} \times ( {K}_{j} - {n}_{j , i}^{( {t}_{j , i} )} ) {M}_{i}} , \underbrace{{I}_{{M}_{i}} , … {I}_{{M}_{i}}}_{{M}_{i} \times {n}_{j , i}^{( {t}_{j , i} )} {M}_{i}} ]}^{T} \\ {A}_{j , i} = {[ \underbrace{{A}_{j , i}^{( 1 )} , … {A}_{j , i}^{( {t}_{j , i} )}}_{{K}_{i} {M}_{i} \times {t}_{j , i} , {M}_{i}} ]}^{T}\end{matrix} \qquad [ EQUATION 11 ]$$

Further, the receiver 300 may obtain the effective IAI channels q and the receiving beamforming matrix u by obtaining a right null space of Fⱼ defined by the Equation 10.

Based on the effective IAI channels q and the receiving beamforming matrix u produced by passing through the aforementioned processes, the receiver 300 may control the multiple antennas to transmit data. In this case, the receiver 300 may transmit the channel information, i.e., information on the receiving beamforming matrix and the effective IAI channels to the transmitter 350 as shown in FIG. 3. The transmitter 350 then produces a transmitting precoding vector for transmitting data using the channel information and transmits the data based on the precoding vector.

The transmitter 350 may include an effective IAI determination unit 352, a channel information sharing unit 354, and a precoding vector producing unit 356, which compose the transmitting signal processing apparatus for interference alignment.

The effective IAI determination unit 352 serves to determine a fixed number of effective IAI channels among the fed-back channel information H. The symbol ‘q’ indicated in the Equation 9 is defined as information on the effective IAI channels, which denotes some of a plurality of interference channels and cannot exceed the number of interference channels.

The channel information sharing unit 354 shares the decoding vector u, the effective IAI channels q, and the channel information H that are fed-back from the receiver among the transmitters that are participated in the interference alignment.

The precoding vector producing unit 356 produces a precoding vector after completing the sharing of the fed-back information among the transmitters.

Power of noise terms may have an effect on the overall system sum-rate at a lower SNR region. In order to cope with the aforementioned effect, therefore, the receiver 300 in the multiple antenna system produces the precoding vector or matrix based on SLNR (signal-to-leakage-interference-and-noise power ratio) taking into consideration both the leakage power and noise power. Herein, the noise power means interference signals, when a transmitter of a user transmits a desired signal to a target receiver, to influence all of remaining other users.

Therefore, the receiver 300 aims to improve the performance in the low SNR region in consideration of SLNR when designing the precoding matrix in the AP 110. That is, the transmitting precoding vector used to transmit m-th data stream from an i-th user supported by the AP 110 may be obtained by producing Vₘ^{[k,i]} satisfying the following Equation 12.

$${v}_{m}^{[ k , i ]} = maxeigvec [ {( \begin{matrix}{\sum }_{{n = 1}_{n \neq m}}^{d} {H}_{i}^{[ k , i ] H} {u}_{n}^{[ k , i ]} {u}_{n}^{[ k , i ] H} {H}_{i}^{[ k , i ]} + \\ {\sum }_{{l = 1}_{l \neq k}}^{Ki} {H}_{i}^{[ l , i ] H} {u}_{m}^{[ l , i ]} {u}_{m}^{[ l , i ] H} {H}_{i}^{[ l , i ]} + {\sum }_{{j = 1}_{j \neq k}}^{C} {Q}_{j , i}^{( s )} {Q}_{j , i}^{( s ) H} + {σ}^{2} I\end{matrix} )}^{- 1} {H}_{i}^{[ k , i ] H} {u}_{m}^{[ k , i ]} {u}_{m}^{{[ k , i ]}^{H}} {H}_{i}^{[ k , i ]} ] \qquad [ EQUATION 12 ]$$

By producing the transmitting precoding vector satisfying the Equation 12, the inter-user interference (abbreviated as ‘iUi’), inter-AP interference, and inter-stream interference that may be caused by the transmission of a plurality of data streams to any one user may be eliminated.

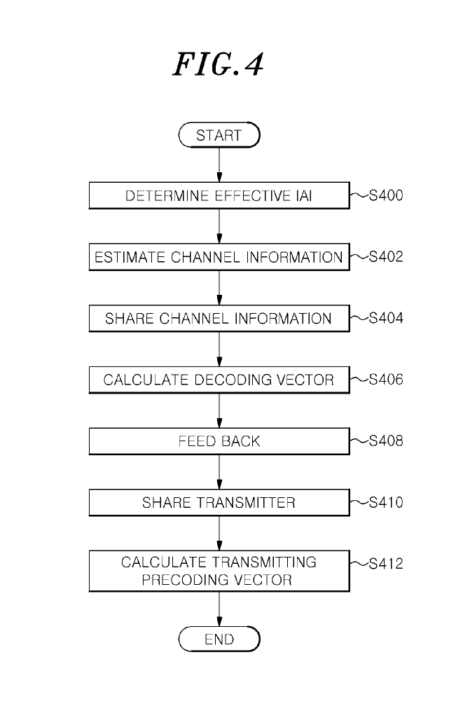

A process for the transmitter and receiver to produce the receiving beamforming matrix and the transmitting precoding vector for the transmission and reception of signals will be described with reference to FIG. 4.

FIG. 4 illustrates a flow diagram of a process of producing a receiving beamforming matrix and transmitting precoding vector by a transmitter and receiver in the wireless communication system in accordance with an embodiment of the present invention.

First, the transmitter 350 determines a fixed number of effective IAI channels in block 5400. As such, when the effective IAI channels are determined and then transmitted to the receiver 300, the receiver 300, e.g., the STA, estimates channel information H from information sent from the transmitter 350 in block 5402.

Next, the receiver 300 shares the channel information among a plurality of receivers belonging to a same ESS in block 5404, and then calculates effective IAI channel information q and decoding vector u using the channel information after sharing the channel information in block S406.

In block 5408, the calculated effective IAI channel information q and the decoding vector u, and the channel information is fed-back to the transmitter 350 from the receiver 300.

The transmitter 350 then shares the effective IAI channel information q, the decoding vector u and the channel information which are fed-back from the receiver 300 among a plurality of transmitters in block 5410, and calculates a transmitting precoding vector in block 5412.

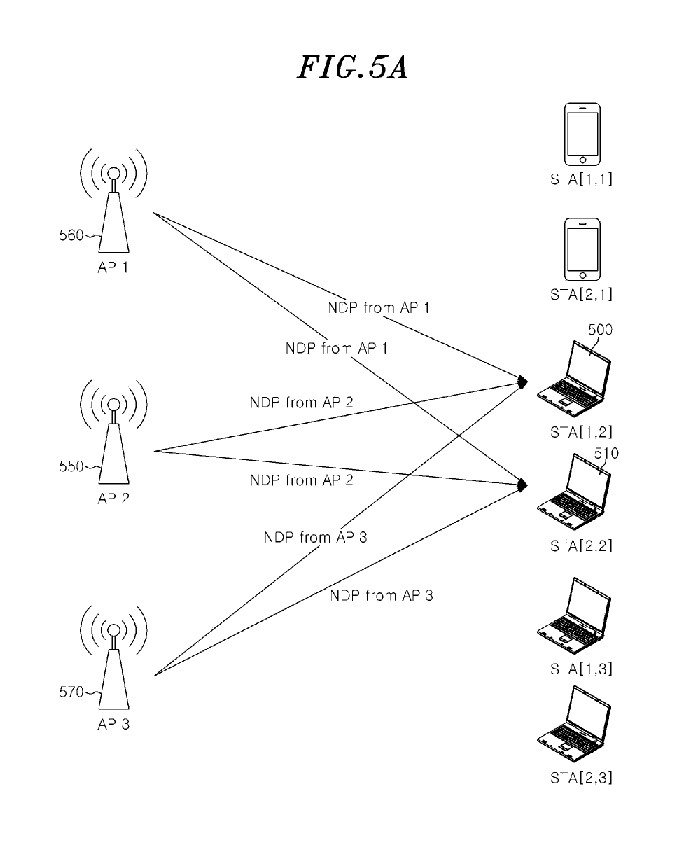

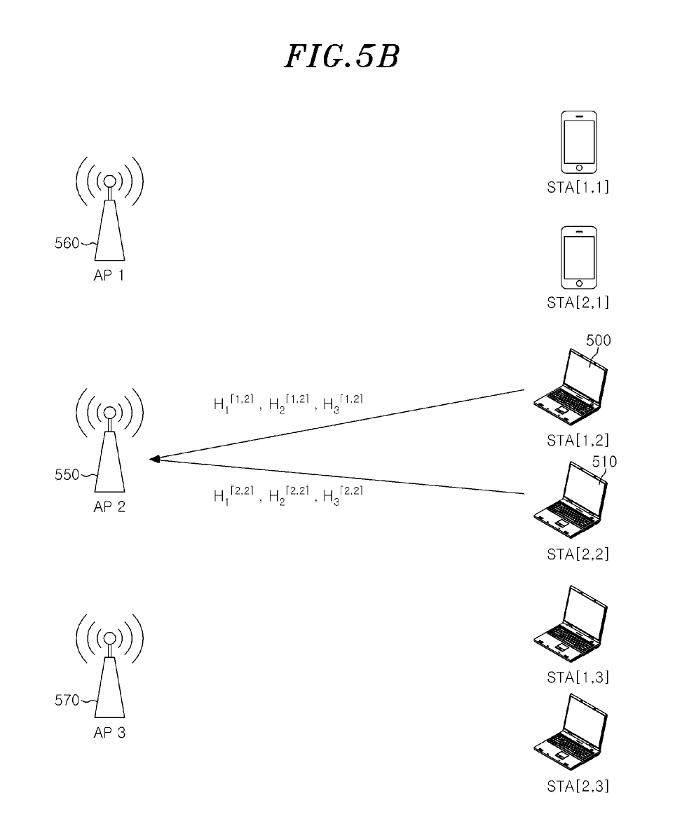

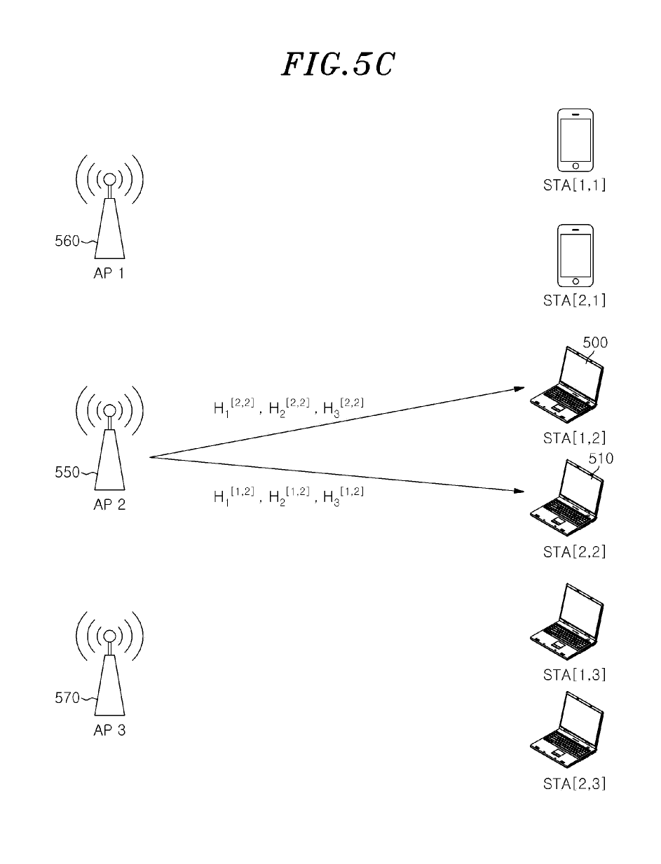

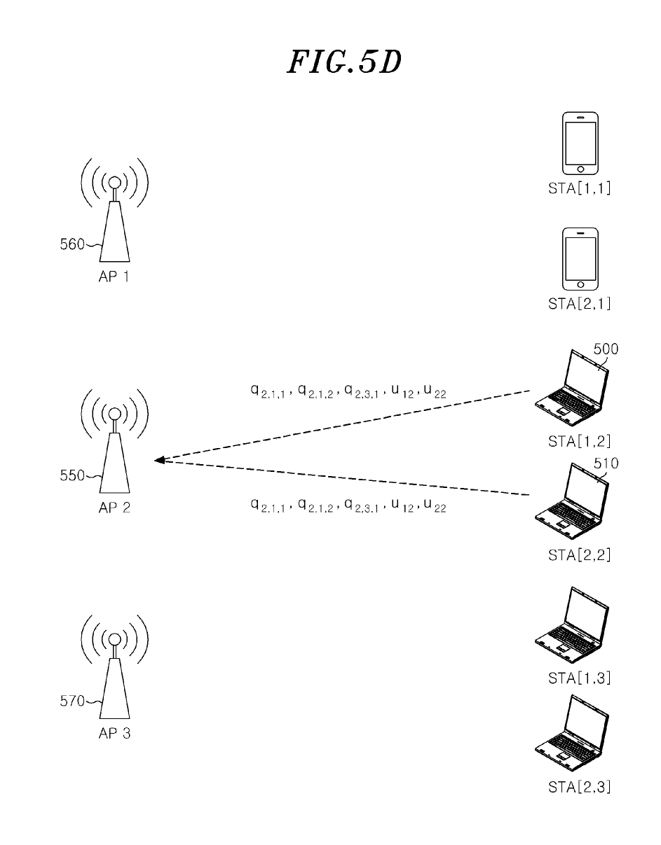

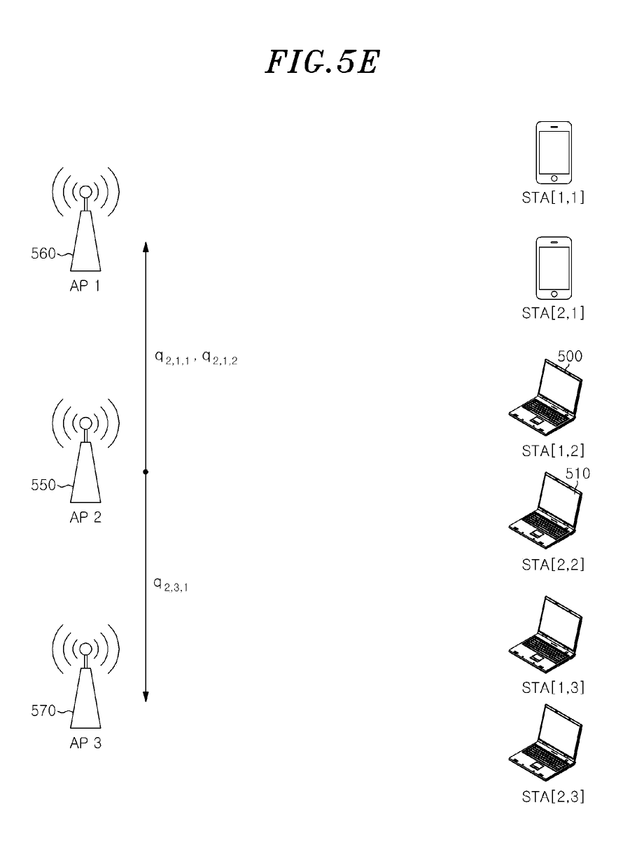

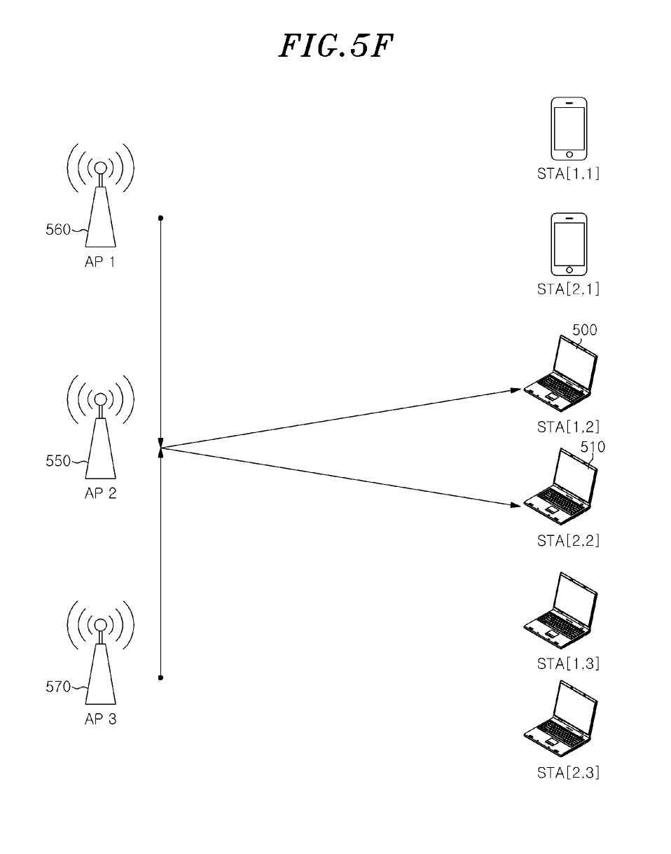

FIGS. 5A to 5F is conceptual diagrams illustrating the interference alignment performed between a transmitter and a receiver in the wireless communication system in accordance with an embodiment of the present invention.

As illustrated in FIG. 5A, APs that are participated in the interference alignment, e.g., transmitters 550, 560 and 570 transmit channel estimation packets called to as NDP (Null Data Packet) to STAs, e.g., receivers 500 and 510.

Each of the receivers 500 and 510 estimates channel information H using the channel estimation packet and then transmits the estimated channel information H to the transmitter 550 that is associated with the receivers 500 and 550, as illustrated in FIG. 5B. In FIG. 5B, Hₖ^{[m,n]} represents the channel information H provided from a k-th AP to an m-th STA belonging to an n-th AP. For example, Hᵢ^{[1,2]} represents channel information provided from a first AP 560 to a first STA 500 belonging to a second AP 550.

The transmitter 550 of the second AP then transmits the channel information H received from the respective receivers 500 and 510 to the opponent receivers 510 and 500, as illustrated in FIG. 5C.

Next, the receivers 510 and 500, which exchange the channel information H with each other, produce effective IAI channels q and decoding vectors u and transmit them to the transmitter 550 associated with the receivers 510 and 500.

The transmitter 550 then transmits the received effective IAI channels q to adjacent APS 560 and 570, as illustrated in FIG. 5E.

Consequently, as illustrated in FIG. 5F, upon receiving the effective IAI channels q from the APS 560 and 570, the transmit 550 performs the interference alignment communication with the receivers 500, 510.

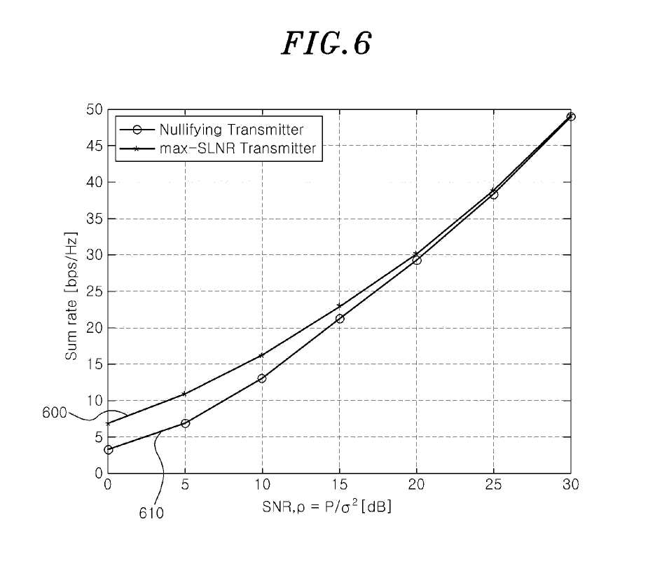

The performance improvement in an operating SNR for the concerned communication system band can be observed from the graph plotted in FIG. 6. That is, FIG. 6 depicts the performance that is measured under an environment having three APS and two STAs that are belong to each AP (thus six STAs in total) wherein each AP has six antennas and each STA has three antennas. In this measurement, the number of test streams to be sent by an AP is fixed as one.

It can seen from FIG. 6 that a graph for a max-SLNR Transmitter 600 to improve the performance in the operating band exhibits an improved performance in the operating band in comparison to a graph for a Nullifying Transmitter 610 based on Zero-Forcing. Further, it is confirmed that the higher the improved performance of SNR is, DoF is kept the same as that in a conventional case.

Meanwhile, the combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer to operate a computer or other programmable data processing apparatus, may provide steps for executing functions described in the respective blocks of the block diagrams and the respective sequences of the sequence diagram.

Moreover, the respective blocks or the respective sequences in the appended drawings may indicate modules, segments, or some of codes including at least one executable instruction for executing a specific logical function(s). In several alternative embodiments, it is noticed that the functions described in the blocks or the sequences may run out of order. For example, two successive blocks and sequences may be substantially executed simultaneously or often in reverse order according to corresponding functions.

The explanation as set forth above is merely described a technical idea of the exemplary embodiments of the present invention, and it will be understood by those skilled in the art to which this invention belongs that various changes and modifications may be made without departing from the scope of the essential characteristics of the embodiments of the present invention.

Therefore, the exemplary embodiments disclosed herein are not used to limit the technical idea of the present invention, but to explain the present invention, and the scope of the technical idea of the present invention is not limited to these embodiments. Therefore, the scope of protection of the present invention should be construed as defined in the following claims and changes, modifications and equivalents that fall within the technical idea of the present invention are intended to be embraced by the scope of the claims of the present invention.

What is claimed is:

1. A method comprising:
determining, by a transmitter, a fixed number of effective IAI channels;
estimating, by a receiver, channel information H through information provided from the transmitter;
sharing, by a receiver, the channel information among a plurality of receivers that are belonging to a same BSS (Basic Service Set);
calculating effective IAI channel information q and decoding vector u using the channel information;
feeding back the calculated effective IAI channel information q and decoding vector u to the transmitter; and
calculating, by the transmitter, a transmitting precoding vector, after sharing the fed-back effective IAI channel information q and decoding vector u, and the channel information H among a plurality of other transmitters.

2. The method of claim 1, wherein said determining the effective IAI channels comprises determining the number of IAI channels, n_{j,i}^{(s)}, aligned in an m-th basis vector q_{j,i,m}^{(s)} and the number of the effective IAI channels, t_{j,i},
wherein an s-th effective IAI channel is expressed as the following Equation:
Q_{j,i}^{(s)}=[q_{j,i,1}^{(s)}, q_{j,i,2}^{(s)}, . . . , q_{j,i,d}^{(s)}]
where d denotes the number of streams to be received by the respective users.

3. The method of claim 2, wherein said determining the effective IAI channels comprises:
determining, each adjacent AP, a total number of IAI channels from an IAI channel on which an adjacent AP affects a first user device to another IAI channel on which the adjacent AP affects an n_{j,i}⁽¹⁾-th user device supported by the receiver as a first effective channel, q_{j,i,m}⁽¹⁾;
determining, each adjacent AP, a total number of IAI channels from an IAI channel on which an adjacent AP affects an n_{j,i}⁽¹⁾+1-th user device supported by the receiver to another IAI channel on which the adjacent AP affects an n_{j,i}⁽¹⁾+n_{j,i}⁽²⁾-th user device as a second effective channel, q_{j,i,m}⁽²⁾; and
determining, each adjacent AP, Kⱼ number of IAI channels on which the adjacent AP affects a user device supported by the receiver as t_{j,i} number of effective channels, q_{j,i,1}^{(s)}, q_{j,i,2}^{(s)}, . . . , q_{j,i,d}^{(s)}

4. An apparatus for processing interference alignment signals (IAI) in a network environment having a plurality of MU-MIMO (Multi User-Multiple Input and Multiple Output) links made up of a plurality of transmitters and receivers, the apparatus comprising:
an effective IAI determining unit adapted to determine effective IAI channels;
a channel information sharing unit adapted to share the effective channel information, channel information H and decoding vector u to be fed-back from the receivers; and
a precoding vector producing unit adapted to produce precoding vector through the use of the effective IAI channel information, the channel information H, and the decoding vector u.

5. The apparatus of claim 4, wherein the precoding vector is employed to perform the precoding on signals to be transmitted from the transmitters to the receivers.

6. An apparatus for processing interference alignment signals (IAI) in a network environment having a plurality of MU-MIMO (Multi User-Multiple Input and Multiple Output) links made up of a plurality of transmitters and receivers, the apparatus comprising:
a channel estimation unit adapted to estimate channel information H based on signals received from the transmitters;
a channel information sharing unit adapted to share the estimated channel information among the plurality of receivers that belong to a same BSS (Basic Service Set);
a decoding vector producing unit adapted to produce a decoding vector u using the channel information; and
a feedback unit adapted to feed back the channel information and the decoding vector to the receivers.
